(19) United States
(12) Patent Application Publication
(10) Pub. No.: US 2025/0265132 A1
(43) Pub. Date: Aug. 21, 2025

(54) METHOD AND SYSTEM FOR PROCESSING DATA BASED ON SHARED VIRTUAL MEMORY

(71) Applicant: NATIONAL CHENG KUNG UNIVERSITY, Tainan City (TW)

(72) Inventors: Chung-ho CHEN, Tainan City (TW); Yu-hua LI, Tainan City (TW); Bo-wei LIN, Tainan City (TW)

(21) Appl. No.: 18/640,920

(22) Filed: Apr. 19, 2024

(30) Foreign Application Priority Data
Feb. 19, 2024 (TW) 113105853

(51) Int. Cl. G06F 9/54; G06T 1/20

(52) U.S. Cl. CPC G06F 9/544; G06T 1/20

(57) ABSTRACT

A method and a system for processing data based on shared virtual memory (SVM) are disclosed. The method is applied to a system which includes a central processing unit (CPU) and a graphics processing unit (GPU) that are configured to share a virtual memory record in a storage medium, and the method includes configuring the CPU to assign a task to be executed by the GPU, wherein data required for the task is associated with the virtual memory record; and configuring the CPU to anchor the data required for the task during a period for the task executed by the GPU. Thus, the number of page fault exceptions can be reduced.

### CROSS REFERENCE TO RELATED APPLICATIONS

This application claims the benefit of and priority to Taiwanese Patent Application No. 113105853, titled “METHOD AND SYSTEM FOR PROCESSING DATA BASED ON SHARED VIRTUAL MEMORY”, filed Feb. 19, 2024, the entirety of which is hereby incorporated herein by reference.

### FIELD OF THE INVENTION

The present disclosure relates to the technical field of heterogeneous system data processing, specifically to a method and a system for processing data based on shared virtual memory.

### BACKGROUND OF THE INVENTION

With development of artificial intelligence (AI) technology, demand for high-computing-power devices such as general-purpose graphics processing units (GPGPUs) has increased. Although graphics processing units have powerful computing capabilities, because transmission speed of data medium (such as PCIe) is slow far from computing speed of a graphics processing unit (GPU), data transfer between a central processing unit (CPU) and the graphics processing unit will become a significant bottleneck in performance and power consumption.

In addition, when a high-computing-power graphics processing unit is integrated into a system with a shared virtual memory (SVM), performance bottlenecks that are encountered include page fault exceptions, in which frequent page fault exceptions will cause the graphics processing unit to reduce the performance. Although related technologies have been provided, such as adding hardware to meet the needs for occurring page fault exceptions, this method has been unable to reduce the number of page fault exceptions, and there is still a need for improvement.

Given the above, a technical solution different from previous technical solutions is necessary to overcome issues in the prior art.

### SUMMARY OF THE INVENTION

An object of the present disclosure is to provide a method for processing data based on shared virtual memory to reduce the number of page fault exceptions.

Another object of the present disclosure is to provide a system for processing data based on shared virtual memory to reduce the number of page fault exceptions.

To achieve the above object, one aspect of the present disclosure provides a method for processing data based on shared virtual memory. The method is applied to a system including a central processing unit and a graphics processing unit, the central processing unit and the graphics processing unit configured to share a virtual memory record in a storage medium, and the method includes: configuring the central processing unit to assign a task to the graphics processing unit, wherein data required for the task is associated with the virtual memory record; and configuring the central processing unit to anchor the data required for the task during the task performed by the graphics processing unit.

In some embodiments, the configuring the central processing unit to anchor the data required for the task during the task executed by the graphics processing unit includes: configuring the central processing unit to set an area related to the data required for the task in a physical memory associated with the virtual memory record to a removal-prohibited-enable state before the graphics processing unit begins executing the task and until the execution of the task is completed to configure the central processing unit to set the area being removal-prohibited in the physical memory associated with the virtual memory record to a removal-prohibited-disable state.

In some embodiments, the configuring the central processing unit to set the area related to the data required for the task in the physical memory associated with the virtual memory record to the removal-prohibited-enable state before the graphics processing unit begins executing the task includes: configuring the central processing unit to prefetch a plurality of pages associated with the data to the physical memory and to prohibit the pages including the data required for the task from being removed from the physical memory before the graphics processing unit begins executing the task.

In some embodiments, the configuring the central processing unit to set the area related to the data required for the task in the physical memory associated with the virtual memory record to the removal-prohibited-enable state includes: configuring the central processing unit to determine whether the data is available in the physical memory; in response to the central processing unit determining the data being available in the physical memory, configuring the central processing unit to set the area related to the data required for the task in the physical memory to the removal-prohibited-enable state; and in response to the central processing unit determining the data being unavailable in the physical memory, configuring the central processing unit to store the data in the physical memory and to set the area related to the data required for the task in the physical memory to the removal-prohibited-enable state.

In some embodiments, the configuring the central processing unit to assign the task to be executed by the graphics processing unit includes configuring the central processing unit to set the task to be a single task or to set the task to include a plurality of batch-operating subtasks in a batch operation.

In some embodiments, the configuring the central processing unit to assign the task to be executed by the graphics processing unit includes configuring the central processing unit to set a locked range of a physical memory associated with the virtual memory record to be 35% to 65% of an access space of the physical memory before the graphics processing unit begins executing the task.

To achieve the above object, another aspect of the present disclosure provides a system for processing data based on shared virtual memory, including a central processing unit and a graphics processing unit that are configured to share a virtual memory record in a storage medium, wherein the virtual memory record is associated with at least one instruction; when the central processing unit executes the at least one instruction, the central processing unit assigns a task to be executed by the graphics processing unit, data required for the task is associated with the virtual memory record, and the central processing unit is configured to anchor the data required for the task during the task executed by the graphics processing unit. In some embodiments, the central processing unit is configured to set an area related to the data required for the task in a physical memory associated with the virtual memory record to a removal-prohibited-enable state before the graphics processing unit begins executing the task and until the execution of the task is completed to configure the central processing unit to set the area being removal-prohibited in the physical memory associated with the virtual memory record to a removal-prohibited-disable state.

In some embodiments, the central processing unit is configured to prefetch a plurality of pages associated with the data to the physical memory and to prohibit the pages including the data required for the task from being removed from the physical memory before the graphics processing unit begins executing the task.

In some embodiments, the central processing unit is configured to determine whether the data is available in the physical memory; in response to the central processing unit determining the data being available in the physical memory, the central processing unit is configured to set the area related to the data required for the task in the physical memory to the removal-prohibited-enable state; and in response to the central processing unit determining the data being unavailable in the physical memory, the central processing unit is configured to store the data in the physical memory and to set the area related to the data required for the task in the physical memory to the removal-prohibited-enable state.

In some embodiments, the central processing unit is configured to set the task to be a single task or to set the task to include a plurality of batch-operating subtasks in a batch operation.

In some embodiments, the central processing unit is configured to set a locked range of a physical memory associated with the virtual memory record to be 35% to 65% of an access space of the physical memory before the graphics processing unit begins executing the task.

In some embodiments, the central processing unit is a RISC-V central processing unit generated by a virtual machine simulation.

In some embodiments, the graphics processing unit includes a task dispatcher, a page fault controller, and a plurality of streaming processing cores; the plurality of streaming processing cores are coupled to the task dispatcher and the page fault controller; the task dispatcher is configured to receive the task and to dispatch the task to one of the plurality of streaming processing cores according to a working status of the plurality of streaming processing cores; the page fault controller is configured to integrate page-fault-exception information from the plurality of streaming processing cores and to issue a page-fault-exception interrupt to the virtual machine; and the plurality of streaming processing cores are configured to process the task dispatched by the task dispatcher.

In some embodiments, the page-fault-exception information includes a virtual address and a streaming processing core number associated with a page fault exception occurring in one of the plurality of streaming processing cores.

In some embodiments, the virtual memory record is a page table.

The method and the system for processing data based on shared virtual memory proposed in the present disclosure are illustrated above with examples. The method can be applied to the system including the central processing unit and the graphics processing unit that are configured to share the virtual memory record in the storage medium, and the method includes: configuring the central processing unit to assign a task to be executed by the graphics processing unit, wherein data required for the task is associated with the virtual memory record; and configuring the central processing unit to anchor the data required for the task during the task executed by the graphics processing unit. Therefore, by locking the required data during the execution of the task, the pages including the required data will not be swapped out during the execution of the task, thereby avoiding page fault exceptions. Therefore, the present disclosure can reduce the number of page fault exceptions, thereby reducing the execution costs (such as time and energy consumption) derived from transferring data, suitable for various data processing scenarios based on shared virtual memory, which is conducive to improving product competitiveness.

### BRIEF DESCRIPTION OF THE DRAWINGS

FIG. 1 is a schematic diagram illustrating a system simulation platform of a graphics processing unit associated with an embodiment of the present disclosure.

FIG. 2 is a schematic diagram illustrating a shared-virtual-memory (SVM) system simulation platform of a graphics processing unit associated with an embodiment of the present disclosure.

FIG. 3a is a schematic diagram illustrating a memory of a graphics processing unit used for the OpenCL 1.2 runtime associated with an embodiment of the present disclosure.

FIG. 3b is a schematic diagram illustrating a memory of a graphics processing unit used for the OpenCL 2.0 runtime associated with an embodiment of the present disclosure.

FIG. 4 is a schematic diagram illustrating a graphics processing unit applied to an SVM system associated with an embodiment of the present disclosure.

FIG. 5 is a schematic diagram illustrating execution time for the graphics processing unit under a prepaging mechanism associated with the embodiment of the present disclosure.

FIG. 6 is a schematic diagram illustrating execution time of a graphics processing unit with an SVM mechanism and a non-SVM mechanism associated with an embodiment of the present disclosure.

FIG. 7 is a schematic diagram illustrating a system for processing data based on shared virtual memory according to an embodiment of the present disclosure.

FIG. 8 is a schematic diagram illustrating a translation look-aside buffer (TLB) running timing sequence associated with an embodiment of the present disclosure.

FIG. 9 is a schematic diagram illustrating the number of page faults of the graphics processing unit with and without a prepaging mechanism associated with the embodiment of the present disclosure.

FIG. 10 is a flowchart illustrating an example of data processing of a graphics processing unit without a prepaging mechanism associated with an embodiment of the present disclosure.

FIG. 11 is a flowchart illustrating an example of data processing of a graphics processing unit with a prepaging mechanism associated with an embodiment of the present disclosure.

FIG. 12 is a flow chart illustrating a method for processing data based on shared virtual memory according to an embodiment of the present disclosure.

### THE DETAILED DESCRIPTION OF PREFERRED EMBODIMENTS

To make the above and other objects, features, and advantages of the present disclosure more apparent and understandable, preferred embodiments of the present disclosure will be described below in detail, along with the accompanying drawings.

A graphics processing unit (GPU) has powerful computing capabilities. However, if the transmission speed of the data medium (such as PCIe) is significantly different from the computing speed of the graphics processing unit, data between a central processing unit (CPU) and the graphics processing unit will become a major bottleneck in performance and power consumption, and there is still room for improvement. Examples are given below, but are not limited to the description here.

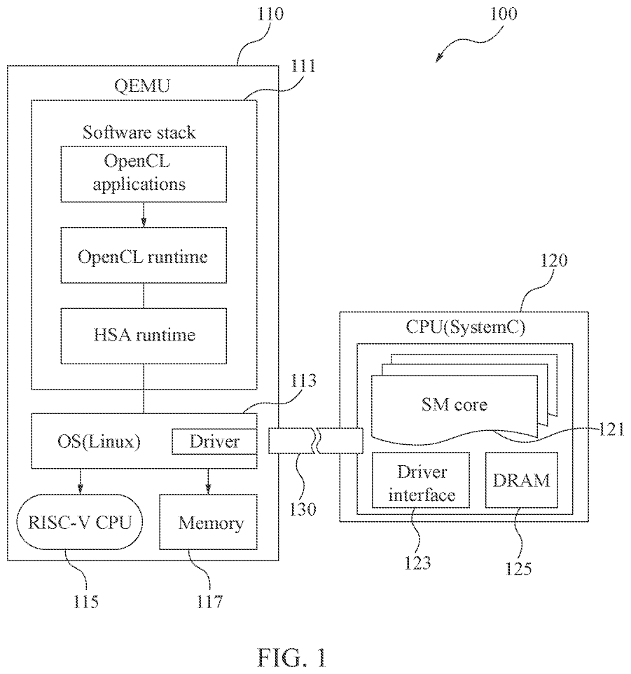

For example, a multi-processor architecture may be a heterogeneous processor architecture, e.g., including a central processing unit and a graphics processing unit. In one example, as shown in FIG. 1, the central processing unit may be a central processing unit used for a computer. A graphics processor simulation platform 100 includes a virtual machine 110, a graphics processing unit 120, and a bridge 130. The virtual machine 110 and the graphics processing unit 120 can be connected through the bridge 130 to exchange data but not limited to the description here. In other application scenarios, the virtual machine 110 can be replaced with a real machine with the same functions (e.g., including many hardware parts required for computer operations).

For example, as shown in FIG. 1, the virtual machine 110 has functions, including hardware parts (such as a central processing unit and a memory) and software parts (such as a software stack, an operating system, and a driver) of another computer simulated in a software manner on a computer host, to help users quickly obtain the operating status of a specific computer configuration. For example, the virtual machine 110 may be a “QEMU” virtual machine but is not limited to the description here, e.g., the virtual machine 110 may also be a virtual machine software such as “Hyper-V”, “VirtualBox”, or “VMWare”.

For example, as shown in FIG. 1, in the QEMU virtual machine, the virtual machine 110 includes a software stack 111. The software stack 111 can be executed on an operating system (such as a Linux operating system) 113. The operation system 113 may have drivers and use a central processing unit (such as a RISC-V instruction architecture CPU) 115 and programs or data in a memory 117. The software stack 111 contains applications and different software execution environments, e.g., the application can be an OpenCL application. The software execution environment can include an OpenCL 1.2 runtime and HSA (heterogeneous system architecture) runtime but is not limited to the description here.

For example, OpenCL is a cross-platform open-source language framework. OpenCL dynamically links a dynamic library loader to load a target hardware library during runtime, allowing developers to run the same program by calling the same set of APIs on various data processing hardware parts, such as a graphics processing unit (GPU), a digital signal processor (DSP), or a field programmable gate array (FPGA). Implementing the internal functions of OpenCL APIs, such as memory management and execution program dispatching, can be completed by HSA runtime.

For example, as shown in FIG. 1, the graphics processing unit 120 can use an electronic system level (ESL) solution to simulate the entire operating environment. When a hardware design is not finalized, a high-end hardware description language such as SystemC can cooperate with a programming language such as C++ to design an architecture of a hardware circuit and perform performance analysis through a time model provided by SystemC. For example, the graphics processing unit 120 may be a single instruction multiple thread (SIMT) architecture general-purpose graphics processing unit (GPGPU), such as CASLab-GPU. The graphics processing unit 120 includes a plurality of streaming multi-processor (SM) cores 121, a driver interface 123, and at least one storage unit (DRAM) 125. For example, when the CPU 115 of the virtual machine 110 dispatches a task to the graphics processing unit 120 through the bridge 130, the graphics processing unit 120 can receive the task, e.g., a task dispatcher is configured to perform operations such as receiving and dispatching tasks. The operations include parsing AQL packets. The packets contain kernel operation-related parameters and can be divided into multiple execution thread blocks (workgroups). The operations also include measuring the current hardware status of all SM cores 121, finding available SM cores 121, and selecting a thread block to be executed by a corresponding SM core 121. For example, a single thread block can be split into multiple thread bundles (warps), in which a single warp includes a plurality of threads. The data required for the SM core 121 to perform the operation process can be stored in the storage unit 125. After each SM core 121 completes executing different thread blocks, the remaining thread blocks are dispatched to the other appropriate SM cores 121 for execution until all execution thread blocks are executed. Then, an interrupt signal is initiated to the central processing unit 115 to instruct that the task has been completed.

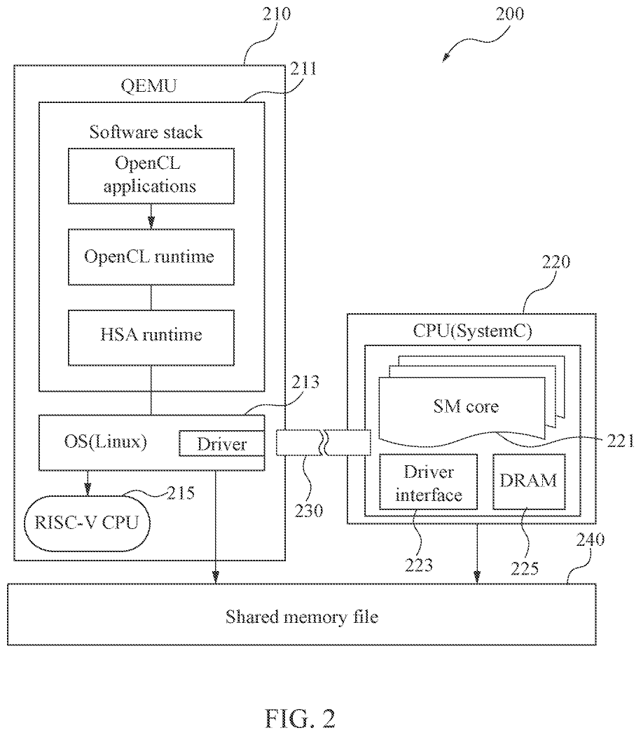

In another example, a central processing unit and a graphics processing unit can also be configured as a shared memory architecture. As shown in FIG. 2, a graphics processor simulation platform 200 includes a virtual machine 210, a graphics processing unit 220, a bridge 230, and a shared memory file 240. The virtual machine 210 and the graphics processing unit 220 can exchange data through the bridge 230. Using a shared page table stored in the shared memory file 240, the virtual machine 210 and the graphics processing unit 220 can point to the same data through the same virtual address.

For example, as shown in FIGS. 1 and 2, similar to the virtual machine 110, the virtual machine 210 includes a software stack 211, an operating system 213, and a central processing unit 215. The software stack 211, the operating system 213, and the central processing unit 215 have substantially the same functions as the software stack 111, the operating system 113, and the central processing unit 115, and they are not described in detail here. The difference from the virtual machine 110 is that the virtual machine 210 does not include a memory. Instead, memory functions required inside the virtual machine 210 are mapped to an external shared memory file 240, such as a file like “/dev/shm/qemu-ram” stored in a computer-readable recording medium. Still, they are not limited to the description here. In addition, similar to the graphics processing unit 120, the graphics processing unit 220 includes a plurality of streaming multi-processor (SM) cores 221, a driver interface 223, and at least one storage unit (e.g., DRAM) 225. The plurality of SM cores 221, the driver interface 223, and the storage unit 225 have substantially the same functions as the SM cores 121, the driver interface 123, and the storage unit 125. The graphics processing unit 220 can read and write the shared memory file 240, such as the file like “/dev/shm/qemu-ram”, so the virtual machine 210 and the graphics processing unit 220 can realize the function of sharing memory.

It should be understood that shared virtual memory (SVM) means that different data processing parts of a system share the same virtual memory. For example, the system includes a host (such as including a CPU) and electronic devices, such as a GPU, an accelerator, or other I/O devices. For example, shared virtual memory (SVM) allows the CPU and GPU to point to the same data through the same virtual address, wherein converting the virtual address into a physical address can be processed by a memory management unit (MMU). For example, data placement methods with and without shared memory are different. Examples are provided as follows but are not limited to the description here.

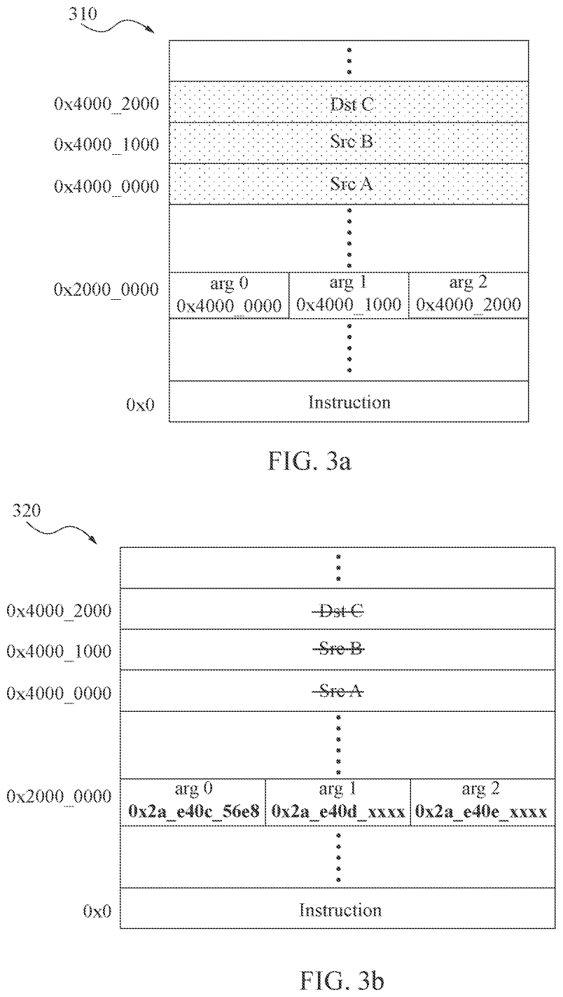

In an aspect, for example, as shown in FIGS. 1 and 3a, blocks starting from a starting address (0x0) of an actual memory data area 310 of the graphics processing unit 120 contain execution instructions for the GPU, and blocks starting from an address (0x2000_0000) contain kernel arguments. For example, values of the kernel arguments (such as “arg 0”, “arg 1”, and “arg 2”) are stored at addresses (0x4000_0000), (0x4000_1000), and (0x4000_2000), respectively. Because the blocks starting from addresses (0x4000_0000), (0x4000_1000), and (0x4000_2000) are continuous array structures, the kernel arguments (such as “arg 0”, “arg 1”, and “arg 2”) store starting addresses of arrays (such as “Src A”, “Src B”, and “Dst C”), respectively, in this way, it can be seen that data placement in GPU memory is a situation in which memory has not been shared with the CPU, such as using the OpenCL 1.2 API “clSetKernelArg”.

In another aspect, for example, as shown in FIGS. 2 and 3b, in the case of shared virtual memory (SVM), such as using the OpenCL 2.0 API “clSetKernelArgSVMPointer”, data placement of an actual memory data area 320 of the graphics processing unit 220 is shown. As shown in FIGS. 3a and 3b, the values of the kernel arguments (such as “arg 0”, “arg 1”, and “arg 2”) have been changed from the addresses (e.g., 0x4000_xxxx) to virtual addresses (e.g., 0x2a_xxxx_xxxx) (e.g., 39 bits) for pointing to the starting addresses of the arrays (such as “Src A”, “Src B”, and “Dst C”), which are addresses corresponding to the CPU memory. Meanwhile, the original physical addresses (e.g., 0x4000_xxxx) do not belong to the arrays (such as “Src A”, “Src B”, and “Dst C”). Namely, memory addresses storing the arrays (such as “Src A”, “Src B”, and “Dst C”) have been changed from memory addresses of the GPU to memory addresses of the CPU, that is, changed from the physical addresses to the virtual addresses. For example, the virtual addresses are used to point to the physical memory addresses.

It should be noted that based on the shared virtual memory (SVM) architecture, the content of shared data can be further determined. For example, not all data in the memory of the GPU are changed to be stored in the memory space of the CPU. For example, execution instructions for the GPU and kernel arguments are still stored in the memory space of the GPU. Herein, it is considered that computation data occupies the largest part of memory space and takes the longest time to transfer from one location to another location, while the execution instructions for the GPU and the kernel arguments not only occupy a small space but are also heavily repetitively read by the GPU. Therefore, if the execution instructions and the kernel arguments are put into the CPU memory space, there will be other input and output devices (I/O devices) in the CPU memory space that will compete for the right to use a bus. As a result, the situation of contention for the bus becomes serious, and it is easy to reduce data access performance.

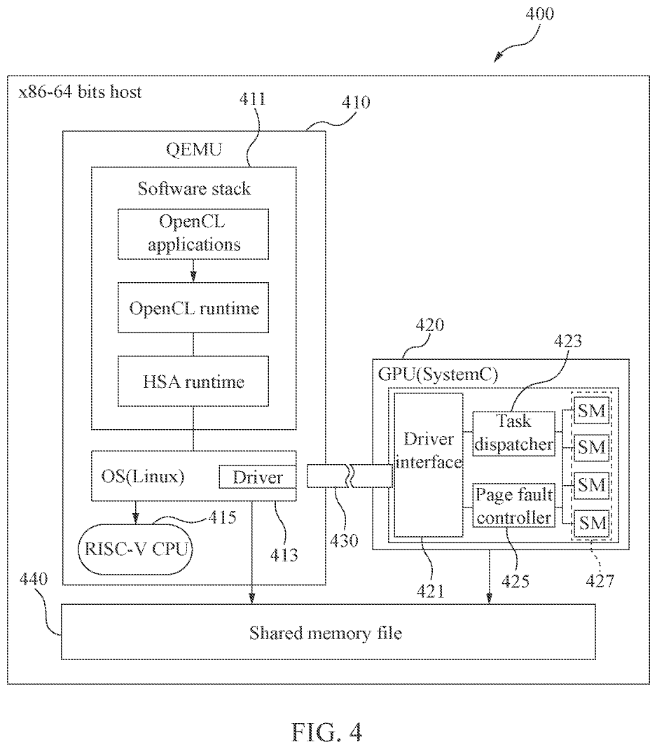

For example, a graphics processing unit with a shared virtual memory architecture may further include a page fault control mechanism. As shown in FIG. 4, a shared-virtual-memory system simulation platform 400 includes a virtual machine 410, a graphics processing unit 420, a bridge 430, and a shared memory file 440. The virtual machine 410 and the graphics processing unit 420 can exchange data through the bridge 430. Using a shared page table stored in the shared memory file 440, the virtual machine 410 and the graphics processing unit 420 can point to the same data through the same virtual address.

As shown in FIGS. 2 and 4, similar to the virtual machine 210, the virtual machine 410 includes a software stack 411, an operating system 413, and a central processing unit 415. The software stack 411, the operating system 413, and the central processing unit 415 have substantially the same functions as the software stack 211, the operating system 213, and the central processing unit 215, and they are not described in detail here.

As shown in FIG. 4, the graphics processing unit 420 includes a driver interface 421, a task dispatcher module 423, a page fault control module 425, and a streaming processing module 427. The driver interface 421 has substantially the same functions as the driver interface 223, used to receive tasks from the central processing unit 215 of the virtual machine 210 or reply to the central processing unit 215 through the bridge 430. The task dispatcher module 423 and the page fault control module 425 are disposed between the driver interface 421 and the streaming processing module 427. The streaming processing module 427 includes several streaming multi-processor (SM) cores. The task dispatcher module 423 is used for receiving and dispatching tasks, including parsing AQL packets, in which the packet contains kernel operation-related parameters and is divided into a plurality of thread blocks. The task dispatcher module 423 can measure the current hardware status of all SM cores to find available SM cores and select a thread area to be executed by a corresponding SM core. For example, a single thread block can be split into multiple thread bundles (warps). The data required by the SM core to execute the operation process is stored in data that the virtual address of the shared memory file 440 points to. It should be noted that, unlike the graphics processing unit 220, the graphics processing unit 420 further includes the page fault control module 425, which can reduce the number of page fault exceptions. Examples are given below but are not limited to the description here.

For example, comparing performance impact of reducing the number of page faults, a non-shared virtual memory system (e.g., a non-svm-system, as shown in FIG. 1) and a shared virtual memory system (e.g., a svm-system, as shown in FIG. 4) are taken as examples.

TABLE 1
QEMU virtual machine and Linux operating system parameter list
QEMU Environment

| Machine Architecture | RISC-V 64 bits (1 core) |
|---|---|
| CPU Frequency | 814 MHz |
| CPI | 1 |
| System Memory | 4 GB |
| Linux Kernel Version | 5.7.7 |

Table 1 shows a parameter list of the virtual machine (such as the QEMU virtual machine and the Linux operating system).

TABLE 2
Graphics processing parameter list
GPU Configuration

| | |
|---|---|
| SM Number | 4 cores |
| Frequency | 200 MHz |
| Workgroup Number | 8 workgroups per SM |
| Thread and Warp | 32 threads per warp, 48 warps per SM |
| Number | |
| Data Cache | 16 KB (4 way, 128-byte line, 32-set) |
| | hashed index, 16MSHR |
| Instruction Cache | 16 KB (2 way, 64-byte line, 128-set) |
| DRAM Model | 4 channels, DDR4 1200 MHz |

Memory Management Unit (MMU)

| | |
|---|---|
| Data TLB | 64-entry, fully-associative, RR replacement policy |
| MMU Page Cache | 16-entry, fully-associative, RR replacement policy |

Table 2 shows a parameter list of the graphics processing unit.

TABLE 3
List of PolyBench benchmark programs

| Benchmark | Description |
|---|---|
| ATAX | Matrix Transpose and Vector Multiplication |
| 2MM | 2 Matrix Multiplications (D = A.B; E = C.D) |
| 3MM | 3 Matrix Multiplications (E = A.B; F = C.D; G = E.F) |
| 2DCONV | 2-D Convolution |
| 3DCONV | 3-D Convolution |
| BICG | BiCG Sub Kernel of BiCGStab Linear Solver |
| GEMM | Matrix-multiply C = alpha.A.B + beta.C |
| GESUMMV | Scalar, Vector and Matrix Multiplication |
| MVT | Matrix Vector Product and Transpose |
| STRK | Symmetric rank-k operations |

Table 3 shows a list of PolyBench benchmark programs executed for comparison.

For example, in an SVM system, data transferring between the central processing unit (CPU) and the graphics processing unit (GPU) becomes a performance bottleneck, and the graphics processing unit also faces page fault exceptions. For example, according to experimental results for QEMU mentioned above, the CPU takes an average of 267.5 milliseconds (ms) to handle a page fault exception. In other words, when a page fault exception occurs, a load-store unit (LSU) will stop for 53500 cycles. In the embodiment of the present disclosure, to reduce the frequency of page fault exceptions, an example way is “preparing.” For example, before the graphics processing unit starts to execute the task, a plurality of pages including required data are prefetched into a memory. The following examples illustrate, but are not limited to, experimental results using the present mechanism.

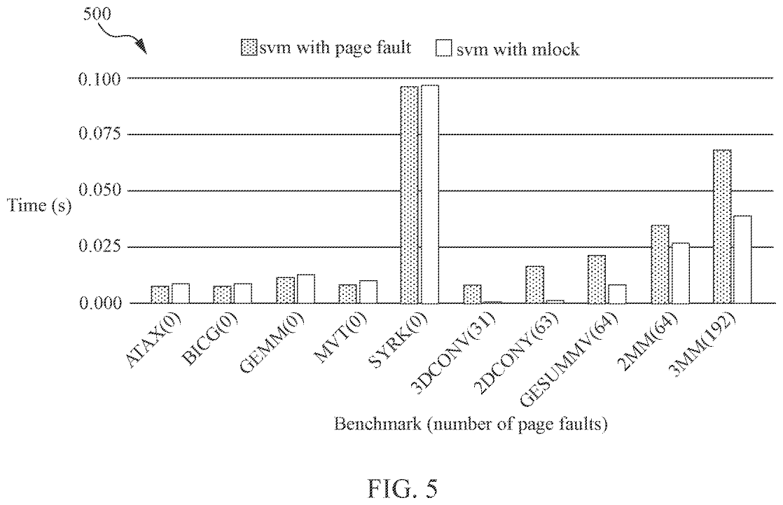

For example, as shown in FIG. 5, according to an experimental result 500, comparing the GPU execution without the “prepaging” mechanism (such as “svm with page faults”) with the GPU execution with the “prepaging” mechanism (such as “svm with mlock”), when no page fault exception occurs, many “benchmark programs (simulating the number of page faults)” are used, such as “ATAX(0)”, “BICG(0)”, “GEMM(0)”, “MVT(0)”, and “SYRK(0)”, and when a page fault exception occurs, many “benchmark programs (simulating the number of page faults)” are used, such as “3DCONV(31)”, “2DCONV(63)”, “GESUMMV(64)”, “2MM(64)”, and “3MM(192)”. As shown in FIG. 5, when a page fault exception occurs, the GPU execution time with a “prepaging” mechanism (such as “svm with mlock”) is significantly lower than that without a “prepaging” mechanism (such as “svm with page faults”). Therefore, the “prepaging” mechanism of the embodiment of the present disclosure can indeed reduce the GPU execution time in the scenario of simulating the occurrence of page faults. The main reason is to reduce the number of page faults.

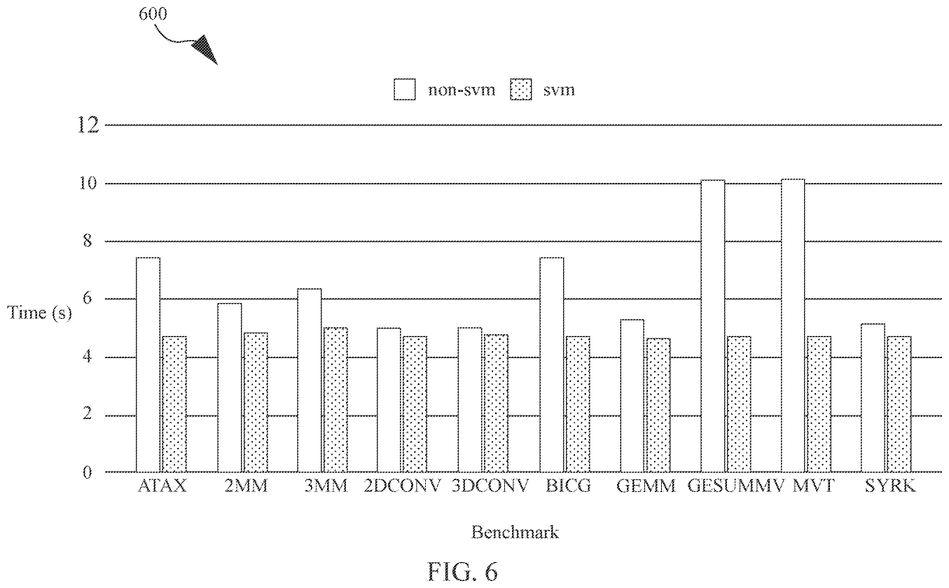

As shown in FIG. 6, according to an experimental result 600, a horizontal axis represents different benchmark programs, and a vertical axis represents the execution time in seconds. It can be seen from the comparison of the total execution time of the PolyBench program on the “non-shared virtual memory system” (i.e., “non-svm”) and the “shared virtual memory system” (i.e., “svm”), “shared virtual memory system” (i.e., “svm”) can improve performance about 25% by reducing data transmission time. It can also reduce the power consumption cost required to transfer data in actual hardware operation.

In another aspect, an embodiment of the present disclosure discloses a system for processing data based on shared virtual memory, including a central processing unit and a graphics processing unit that are configured to share a virtual memory record in a storage medium, wherein the virtual memory record is associated with at least one instruction; when the central processing unit executes the at least one instruction, the central processing unit assigns a task to be executed by the graphics processing unit, data required for the task is associated with the virtual memory record, and the central processing unit is configured to anchor the data required for the task during the task executed by the graphics processing unit. Examples are given below, but they are not limited to the description here.

For example, herein, “anchor” means using a command with a higher priority to prevent a page from being swapped out, so that the data in the page will always exist in the physical memory until canceling anchor; in addition, the computer can be a physical computer or a virtual machine with software and hardware cooperating functions. Herein, the description only takes a virtual machine as an example but is not limited to the description here.

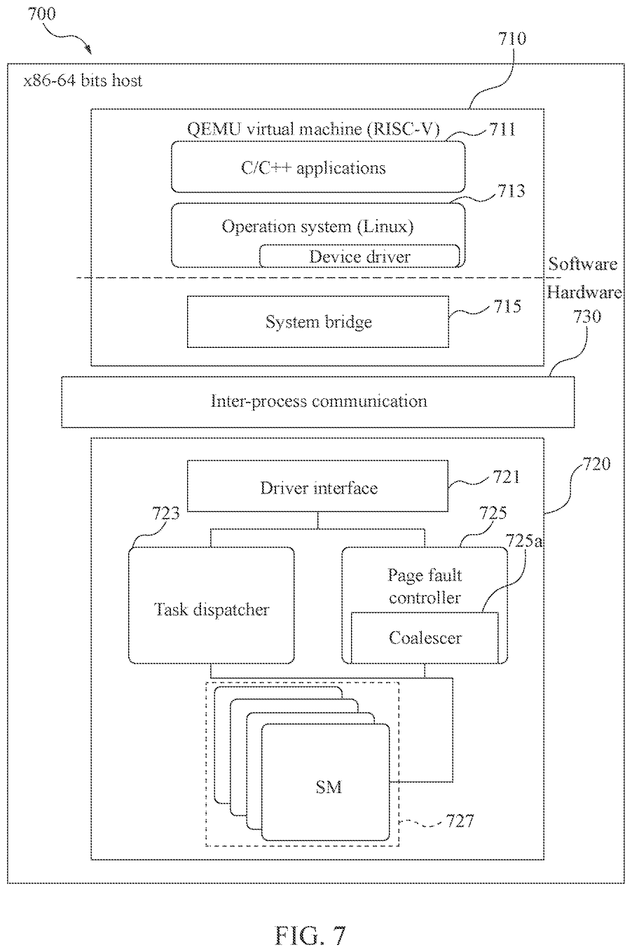

For example, as shown in FIG. 7, an architecture having a virtual machine and a graphics processing unit with a page-fault-exception control mechanism, e.g., a host 700, such as an x86-64-bit host, includes a virtual machine (such as a QENU virtual machine based on a RISC-V central processing unit) 710 and a graphics processing unit (such as a CASLab-GPU) 720. The virtual machine 710 and the graphics processing unit 720 can communicate through an inter-process communication unit 730.

In some embodiments, the central processing unit is a RISC-V central processing unit generated by a virtual machine simulation. But it is not limited to the description here. The central processing unit can also be a RISC-V central processing unit or other central processing units with a hardware architecture.

In some embodiments, the graphics processing unit comprises a task dispatcher, a page fault controller, and a plurality of streaming processing cores; the plurality of streaming processing cores are coupled to the task dispatcher and the page fault controller; the task dispatcher is configured to receive the task and to dispatch the task to one of the plurality of streaming processing cores according to a working status of the plurality of streaming processing cores; the page fault controller is configured to integrate page-fault-exception information from the plurality of streaming processing cores and to issue a page-fault-exception interrupt to the virtual machine; and the plurality of streaming processing cores are configured to process the task dispatched by the task dispatcher. Examples are given below, but are not limited to the description here.

As shown in FIG. 7, similar to the aforementioned virtual machine, the virtual machine 710 includes a software module (such as an application 711 written in C/C++ codes and an operating system (such as Linux) 713 containing a device driver) and a hardware module (such as system bridge 715). The graphics processing unit 720 includes a driver interface 721, a task dispatcher 723, a page fault controller 725, and a streaming processing module 727. The streaming processing module 727 includes a plurality of streaming multi-processor (SM) cores. As shown in FIG. 7, the driver interface 721 is configured to receive a task from the system bridge 715 of the virtual machine 710 or reply a related message of the task to the system bridge 715 of the virtual machine 710 through the inter-process communication unit 730. The task dispatcher 723 is configured to receive and dispatch tasks, including parsing AQL packets. The packet contains kernel operation-related parameters and can be divided into multiple execution thread blocks. The task dispatcher 723 can measure the current hardware status of all SM cores, find available SM cores, and select one of the thread blocks to be executed by a corresponding SM core. For example, a single thread block can be split into multiple thread bundles (warps). The page fault controller 725 is independent of all SM cores and has a coalescer 725a. The coalescer 725a is configured to receive and integrate page-fault-exception-related information from all SM cores of the streaming processing module 727, such as a virtual address and its SM number (SM ID) that the page fault exception occurs. The page fault controller 725 can send a page fault interrupt to the virtual machine 710 through the driver interface 721 for subsequent processing after integrating the page-fault-exception-related information.

In some embodiments, the page-fault-exception information includes a virtual address and a streaming processing core number associated with a page fault exception occurring in one of the plurality of streaming processing cores.

For example, as shown in FIG. 7, the virtual machine 710 in the host 700 will receive two types of interrupts: a task completion interrupt (such as a done interrupt) signal sent by the GPU after completing the task execution and the above-mentioned page fault interrupt signal. For example, the device driver in the operating system 713 can process the page fault interrupt signal. After information that a virtual address (e.g., associated with a shared memory file) occurs is received, the device driver will check the correctness of the virtual address and call a page-fault-exception handling function, such as “handle_mm_fault” kernel function, the virtual address will be sent to the page-fault-exception handling function in which the page fault exception is processed by the operating system 713. After the operating system 713 completes the process of the page fault exception, this information will be sent to the page fault controller 725 through the device driver and then be sent to each SM core of the streaming processing module 727.

For example, as shown in FIG. 7, in the host 700, the device driver calls the page fault exception handling function to handle a page missing exception. The operating system 713 can perform related data processing processes. For example, according to the Lease Frequently Used (LFU) algorithm, the less frequently used page is swapped out. Currently, the GPU does not know whether the page swapped out by the operating system 713 exists in the TLB (i.e., translation lookaside buffer) of the GPU. Therefore, TLB consistency situations must be handled.

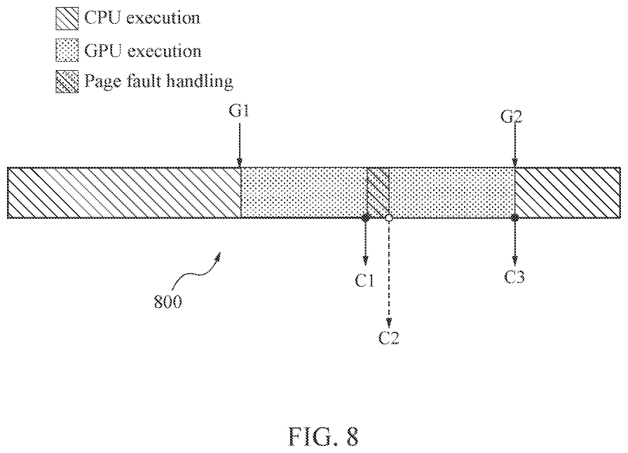

For example, as shown in FIG. 8, in a buffer timing sequence example 800, many blocks with oblique lines represent periods when the CPU (such as the RISC-V) executes computations, and many blocks with dots represent periods when the GPU (such as the CASLab-GPU) executes computations. Suppose the operation period is developed based on the timeline, from left to right. In that case, the CPU first performs pre-processing, such as preparing data and dispatching tasks to the GPU for execution. Then, at the moment, G1, the GPU starts to compute. Finally, at the moment G2, the GPU operation is completed.

It should be noted that, as shown in FIG. 8, during the GPU computation, such as between the moments G1 and G2, an operation C1 (such as refreshing the TLB of the CPU) is performed first, and then an operation C2 (such as refreshing the TLB of the GPU) is performed. During performing operations C1 and C2, a time block represents operations executed by the CPU and GPU simultaneously (e.g., a block with both oblique lines and a dotted cloud shown in the figure), i.e., a period for handling page fault exceptions during which the SM core that the page fault exception occurs will stop the operation of the load store unit (LSU). Still, it will not affect the continued execution of an execution (EXE) unit. Meanwhile, other SM cores will continue to execute the operation; subsequently, at the moment G2 operations of the GPU are completed, operation C3 is executed (such as refreshing the TLB of the CPU), and the result of the operations of the GPU is handed over to the CPU for processing. In one example, when the operating system 713 completes a page fault handling (page fault handling), the TLB of the GPU must be cleared because the CPU does not know whether the page being swapped out exists in the TLB of the GPU at this time. For example, during the execution of a page table walker, when the GPU performs address translation, an access bit and a dirty bit (i.e., a page rewrite-flag bit) of a page table entry will be changed. Therefore, when it is the CPU's turn to execute, the TLB of the CPU must also be cleared to make the TLB contents of the CPU and the GPU consistent.

Regarding GPU performance, frequent occurrence of page fault exceptions will lead to low GPU performance, and the time taken for the GPU to process page fault exceptions is longer than the time taken for the CPU to process page fault exceptions. The reason is that after the GPU initiates an interrupt, the GPU needs to wait for the CPU to respond. However, the CPU may be executing other programs or processing interrupt signals from other input-output devices (I/O) simultaneously, causing the CPU to fail to process the interrupt signal from the GPU in time. For example, a specific algorithm (such as the Pager algorithm) can be used to perform a determination process. If a piece of data exceeds a threshold, the data will be left on a data disk without being moved into the main memory. If this algorithm will cause multiple page fault exceptions when the program is running, it is acceptable for the CPU. However, for a GPU with high throughput, if it encounters page fault exceptions, it will be significantly affected. Therefore, page fault exceptions should be avoided. For example, the pre-fetching page mechanism described in the embodiment of the present disclosure, i.e., prepaging, is used. Examples are provided as follows but are not limited to the description here.

In some embodiments, before the graphics processing unit begins executing the task, the central processing unit is configured to set an area related to the data required for the task in a physical memory associated with the virtual memory record to a removal-prohibited-enable state, e.g., the central processing unit is configured to prefetch the pages associated with the data to the physical memory and to prohibit the pages including the data required for the task from being removed from the physical memory until the execution of the task is completed to configure the central processing unit to set the area being removal-prohibited in the physical memory associated with the virtual memory record to a removal-prohibited-disable state. Examples are given below but are not limited to the description here.

For example, in one example, the prepaging mechanism may be composed of two system calls executed by the CPU, such as “mlock” and “unlock”, wherein the function of “mlock” is first to move the specified paging data into the main memory (i.e., the shared physical memory) and then to lock the specified paging data, in which the locking means that if the data needs to be swapped out of the memory, such as adopting “Context Switch” or “Page Fault Handling”, then the locked paging data will not be swapped out of the main memory. In addition, “munlock” provides an unlocking function corresponding to the “mlock”. For example, before the GPU performs computations, “mlock” is used to move computation data required by the GPU, store it in a data disk, and lock the computation data into the main memory. The locked computation data is maintained in the main memory. Thus, during computations performed by the GPU, no page fault will occur, resulting from no data being found in the main memory. In an example, all global data is locked using “mlock”, and results of GPU computing time are compared with and without using “mlock”. As shown in FIG. 5, when no page fault exception occurs (i.e., the number of simulated pages fault exceptions is zero), the execution time of the svm with “mlock” will be slightly longer than that of the svm with page faults. However, suppose page fault exceptions occur (i.e., the number of simulated page fault exceptions is not equal to zero). In that case, the execution time of svm with page faults is much longer than that of svm with “mlock”, wherein a difference can be up to 4 to 5 times an average value. It can be seen that although the use of the prepaging mechanism will have a slight time cost in the case that the page fault exception does not occur originally, as long as the conventional page fault exception is encountered, the prepaging mechanism of the embodiment of the present disclosure significantly improves data processing performance due to reducing the number of page fault exceptions. Examples are given below, but are not limited to the description here.

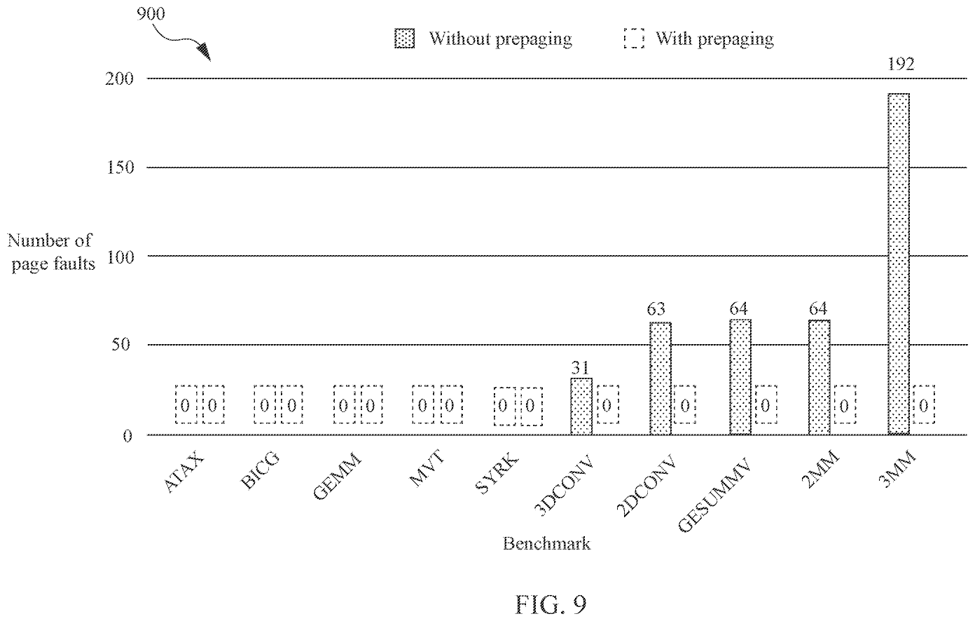

For example, as shown in FIG. 9, in experimental result 900, different benchmark programs are used for testing, in which benchmark programs such as “ATAX”, “BICG”, “GEMM”, “MVT”, and “SYRK” without page fault exceptions have the number of page faults equal to zero regardless of whether there is a prepaging mechanism. It should be noted that, as shown in FIG. 9, benchmark programs, such as “3DCONV”, “2DCONV”, “GESUMMV”, “2MM”, and “3MM” with page fault exception simulation situations, are used. In the case of no prepaging mechanism being applied, different numbers of page fault exceptions occur, such as “3DCONV” (the number of page faults is 31), “2DCONV” (the number of page faults is 63), “GESUMMV” (the number of page faults is 64), “2MM” (the number of page faults is 64) and “3MM” (the number of page faults is 192). In comparison, under the same situation, benchmark programs such as “3DCONV”, “2DCONV”, “GESUMMV”, “2MM”, and “3MM” have no page fault exception occurred (the number of page faults is zero) in the case of applying prepaging mechanism. The reason is that in the case that a page fault exception may occur not yet applying a prepaging mechanism, the prepaging mechanism can be applied to use “mlock” to lock the memory to prevent the operating system from randomly replacing the data originally stored in this memory, ensuring that the original specific data that will generate page fault exceptions are stored in the memory to avoid page fault exceptions caused by data not being in the memory. Thus, the prepaging mechanism of the embodiment of the present disclosure can reliably avoid page fault exceptions and reduce the number of page fault exceptions.

In some embodiments, the central processing unit is configured to set a locked range of a physical memory associated with the virtual memory record to be 35% to 65% of an access space of the physical memory before the graphics processing unit begins executing the task. Examples are given below, but are not limited to the description here.

Optionally, in an example, when the amount of computing data becomes larger and larger, the “mlock” execution mechanism can also be adaptively changed to avoid the unrestricted use of “mlock” to affect the overall data processing performance. For example, because “mlock” sets the memory as specific data will not be swapped out, the specific data will always occupy memory space, limiting the memory space that other programs can use. In one example, a memory size locked by “mlock” can be set to 35% to 65% of the total memory size, such as 35%, 40%, 45%, 50%, 55%, 60%, or 65%. In an example, if the memory size is set to 4 GB in the QEMU environment, then the memory size that the GPU can use is 2 GB, but it is not limited to the description here and can also be other values. Taking a notebook computer as an example, the memory capacity is about 4 GB to 16 GB, and the memory space that the prepaging mechanism can use is about 2 GB to 8 GB. This memory space is better than the memory space of some commercially available GPU products. In addition to increasing the memory space to enhance performance, breaking the execution performance into parts can be used to use multiple GPU products with a small amount of memory space to enhance performance. Below are examples of processing data from cases with and without prepaging mechanisms to illustrate the differences between the two cases, but they are not limited to the description here.

Optionally, a method of executing large programs on a small GPU can also be used, such as dividing the large programs into multiple batches and dispatching tasks to the GPU for execution in batches. For example, before each batch is executed, “mlock” is performed first, and then “munlock” is performed after the batch is processed. In this way, the effect of reducing the number of page fault exceptions can be maintained, thereby reducing the overall execution time and power consumption of the GPU. The following examples illustrate non-batch and batch data processing processes, but are not limited to the description here.

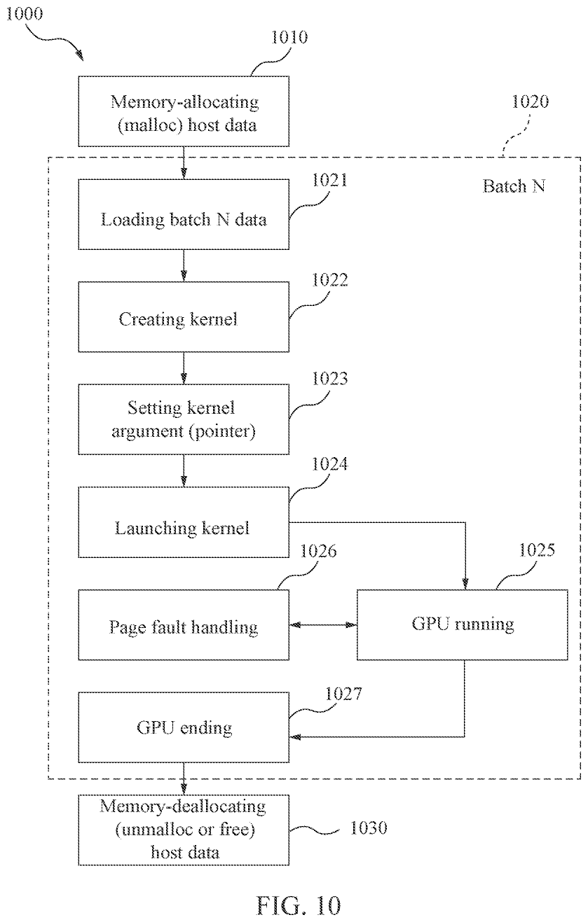

For example, a mechanism without prepaging is taken as an example, as shown in FIG. 10, an execution process 1000 of a non-batch version of a mechanism without prepaging includes: step 1010, memory-allocating (malloc) host data, and then proceeding to step 1021; step 1021, loading data, and then proceeding to step 1022; step 1022, creating a kernel program, and then proceeding to step 1023; step 1023, set the a kernel argument (pointer), and then proceeding to step 1024; step 1024, launching the kernel program, and then proceeding to step 1025; step 1025, performing a GPU execution phase (running), and then, if a page fault exception occurs, proceeding to step 1026, otherwise, proceeding to step 1027; step 1026, performing a page fault handling; step 1027, completing operations of GPU (ending), and then proceeding to step 1030; step 1030: memory-deallocating (unmalloc or free) host data.

In another example, as shown in FIG. 10, an execution process 1000 of a batched version of a mechanism without prepaging includes: a batched step 1020, performing a batch operation, e.g., multiple single-batch-operating tasks, such as the Nth (e.g., N is a positive integer such as 1, 2, 3, . . . ,) batch-operating task, each batch-operating task includes: steps 1021 to 1027, wherein the data for step 1021 is adaptively changed to the Nth batch data so that small GPUs can be used to execute large programs in batches.

It can be seen from FIG. 10 that in the mechanism without prepaging, regardless of whether the batched step 1020 is involved or not, if the number of page fault exceptions is higher, step 1026 will be used to perform page fault handling more times, resulting in a more frequent round trip between step 1025 and step 1026, thereby increasing the overall execution time and power consumption of the GPU.

In some embodiments, the central processing unit is configured to determine whether the data is available in the physical memory; in response to the central processing unit determining the data being available in the physical memory, the central processing unit is configured to set the area related to the data required for the task in the physical memory to the removal-prohibited-enable state; and in response to the central processing unit determining the data being unavailable in the physical memory, the central processing unit is configured to store the data in the physical memory and to set the area related to the data required for the task in the physical memory to the removal-prohibited-enable state. Examples are given below, but are not limited to the description here.

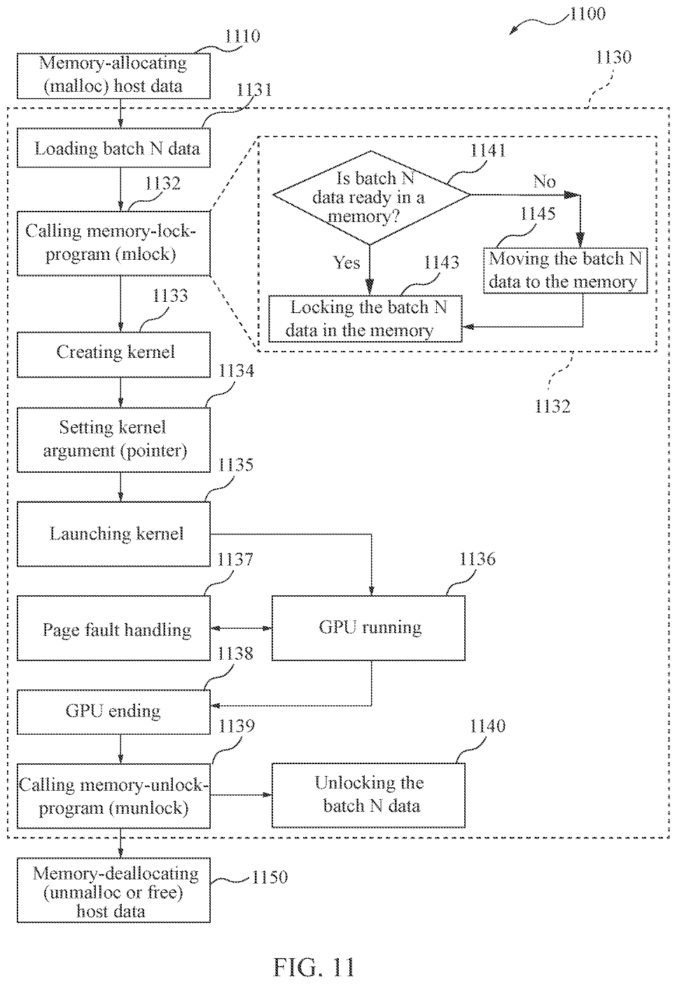

For example, a mechanism with prepaging is taken as an example, as shown in FIG. 11, an execution process 1100 of a non-batch version of a mechanism with prepaging includes: step 1110, memory-allocating (malloc) host data, and then proceeding to step 1131; step 1131, loading data, and then proceeding to step 1132; step 1132, calling a memory-lock-program (e.g., including “mlock” function), then proceeding to step 1133, wherein step 1132 includes: steps 1141, 1143 and 1145, in which, step 1141, determining whether data is available in a memory, if the determination is positive (such as “Yes”), proceeding to step 1143, if the determination is negative (such as “No”), proceeding to step 1145; step 1143, locking the data in the memory, e.g., locking data required for a task in a physical memory associated with a virtual memory record to prevent the pages including the data from being swapped out in response to at least one instruction such as moving, deleting or changing the data; step 1145, moving the data to the memory, and then proceeding to step 1143; step 1133, creating a kernel program, then proceeding to step 1134; step 1134, setting a kernel argument (pointer), then proceeding to step 1135; step 1135, launching the kernel program, then proceeding to step 1136; step 1136, performing a GPU execution phase (running), and then, if a page fault exception occurs, proceeding to step 1037, otherwise, proceeding to step 1038; step 1137, performing a page fault handling; step 1138, completing operations of GPU (ending), and then proceeding to step 1139; step 1139, calling a memory-unlock-program (e.g., including “munlock” function), and then proceeding to steps 1140 and 1150; step 1140, unlocking the data; step 1150, memory-deallocating (unmalloc or free) host data.

In another example, as shown in FIG. 11, an execution process 1100 of a batched version of a mechanism with prepaging includes: a batched step 1130, performing a batch operation, e.g., multiple single-batch-operating tasks, such as the Nth (e.g., N is a positive integer such as 1, 2, 3, . . . ) batch-operating task, each batch-operating task includes: steps 1131 to 1140, wherein the data for steps 1131, 1140, 1141, 1143, and 1145 are adaptively changed to the Nth batch data so that small GPUs can be used to execute large programs in batches.

In some embodiments, the central processing unit is configured to set the task to be a single task or to set the task to include a plurality of batch-operating subtasks in a batch operation.

As shown in FIG. 11, in the prepaging mechanism, regardless of whether the batching step 1130 is set or not because the GPU executes “mlock” before executing the task and executes “munlock” after executing the task, it can avoid the situation in which the data required during task execution does not be in the memory to derivative a page fault exception and then to execute step 1137 (performing page fault handling). Thus, the number of executing step 1137 (performing page fault handling) can be effectively reduced, and the number of round trips between step 1136 and step 1137 can also be effectively reduced. In this way, the overall execution time and power consumption of the GPU can be reduced.

The above examples illustrate the system for processing data based on shared virtual memory according to the embodiment of the present disclosure. Still, they are not limited to the description here.

Correspondingly, the present disclosure also provides a method for processing data based on shared virtual memory, which can be applied to a system (such as a system for processing data based on shared virtual memory). The system includes a central processing unit and a graphics processing unit. The central processing unit and the graphics processing unit are configured to share a virtual memory record, such as a page table, in a storage medium. Examples are given below but are not limited to the description here.

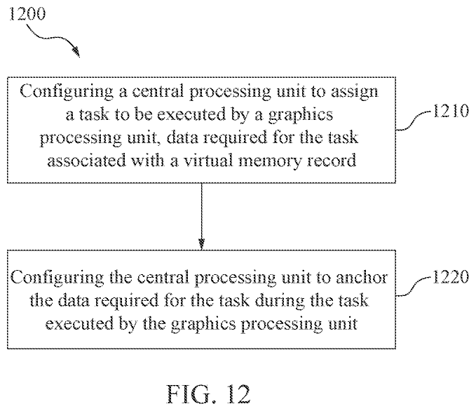

For example, as shown in FIG. 12, a method example 1200 may include steps 1210 and 1220.

Optionally, in some embodiments, as shown in FIG. 12, step 1210 configures the central processing unit to assign a task to be executed by the graphics processing unit, wherein the data required by the task is associated with the virtual memory record; step 1220 configures the central processing unit to anchor the data required for the task during the task executed by the graphics processing unit.

In some embodiments, as shown in FIG. 12, in step 1210, the configuring the central processing unit to assign the task to be executed by the graphics processing unit includes configuring the central processing unit to set the task to be a single task or to set the task to include a plurality of batch-operating subtasks in a batch operation, an example of which is shown as 1100 in FIG. 11. For related content, please refer to the above system embodiment and it will not be described again.

In some embodiments, as shown in FIG. 12, in step 1210, the configuring the central processing unit to assign the task to be executed by the graphics processing unit includes configuring the central processing unit to set a locked range of a physical memory associated with the virtual memory record to be 35% to 65% of an access space of the physical memory before the graphics processing unit begins executing the task. The relevant content has been mentioned above. Please refer to the above system embodiment; it will not be described again.

In some embodiments, as shown in FIG. 12, in step 1220, the configuring the central processing unit to anchor the data required for the task during the task executed by the graphics processing unit includes: configuring the central processing unit to set an area related to the data required for the task in a physical memory associated with the virtual memory record to a removal-prohibited-enable state before the graphics processing unit begins executing the task and until the execution of the task is completed to configure the central processing unit to set the area being removal-prohibited in the physical memory associated with the virtual memory record to a removal-prohibited-disable state. The relevant content has been explained above. Please refer to the above system embodiment, and it will not be described again.

For example, as shown in FIG. 12, in step 1220, the configuring the central processing unit to set the area related to the data required for the task in the physical memory associated with the virtual memory record to the removal-prohibited-enable state before the graphics processing unit begins executing the task includes: configuring the central processing unit to prefetch a plurality of pages associated with the data to the physical memory and to prohibit the pages including the data required for the task from being removed from the physical memory before the graphics processing unit begins executing the task. The relevant content has been explained above. Please refer to the above system embodiment, and it will not be described again.

For example, as shown in FIG. 12, in step 1220, the configuring the central processing unit to set the area related to the data required for the task in the physical memory associated with the virtual memory record to the removal-prohibited-enable state includes: configuring the central processing unit to determine whether the data is available in the physical memory; in response to the central processing unit determining the data being available in the physical memory, configuring the central processing unit to set the area related to the data required for the task in the physical memory to the removal-prohibited-enable state; and in response to the central processing unit determining the data being unavailable in the physical memory, configuring the central processing unit to store the data in the physical memory and to set the area related to the data required for the task in the physical memory to the removal-prohibited-enable state, an example of which is shown as the execution process 1100 in FIG. 11. The relevant content has been explained above. Please refer to the above system embodiment, and it will not be described again.

In some embodiments, locking the data required for the task in the physical memory associated with the virtual memory record includes: setting the physical memory associated with the virtual memory record to be locked in a locked memory range of 35% to 65% of the total memory size. The relevant content has been explained above. Please refer to the above system embodiment, and it will not be described again.

On the other hand, the present disclosure further provides a computer program (product). When the computer loads and executes the computer program, the computer can execute many embodiments of the method for processing data based on shared virtual memory as described above. For example, the computer program may include several program instructions, which may be implemented using existing programming languages to execute the various embodiments of the method for processing data based on shared virtual memory as described above. For example, programming languages such as C, C++, Python, R, or their combination, can be used to simulate an architecture of the above-mentioned virtual machine and graphics processing unit with page fault exceptions in software form, but it is not limited to the description here.

On the other hand, the present invention also provides a computer-readable recording medium, such as an optical disk, a pen drive, or a hard disk. The computer can read the program (such as the computer program mentioned above) stored in the recording medium. When the computer loads and executes the computer program, the computer can complete many embodiments of the method for processing data based on shared virtual memory as described above. For example, an architecture of the above-mentioned virtual machine and graphics processing unit with page fault exceptions is simulated in software form.

As mentioned above, the method and system for processing data based on shared virtual memory according to the embodiment of the present disclosure can be applied to the system. The system includes the central processing unit and the graphics processing unit. The central processing unit and the graphics processing unit are configured to share the virtual memory record, such as a page table, in the storage medium. The method includes: configuring the central processing unit to assign a task to be executed by the graphics processing unit, wherein the data required for the task is associated with the virtual memory record; and configuring the central processing unit to anchor the data required for the task during the task executed by the graphics processing unit. Therefore, by locking the required data during the execution of the task, the pages including the data will not be swapped out during the execution of the task, thereby avoiding page fault exceptions. Therefore, the present disclosure can reduce the number of page fault exceptions, thereby reducing the execution costs (such as time and energy consumption) derived from transferring data, suitable for various data processing scenarios based on shared virtual memory, which is conducive to improving product competitiveness.

Although the present invention has been disclosed in preferred embodiments, they are not intended to limit the present disclosure. Any person skilled in the art can make various changes and modifications without departing from the spirit and scope of the present disclosure. Therefore, the protection scope of the present disclosure shall be determined by the appended patent application scope.

What is claimed is:

1. A method for processing data based on shared virtual memory, applied to a system comprising a central processing unit and a graphics processing unit, the central processing unit and the graphics processing unit configured to share a virtual memory record in a storage medium, wherein the method comprises:
configuring the central processing unit to assign a task to be executed by the graphics processing unit, wherein data required for the task is associated with the virtual memory record; and
configuring the central processing unit to anchor the data required for the task during the task executed by the graphics processing unit.

2. The method as claimed in claim 1, wherein the configuring the central processing unit to anchor the data required for the task during the task executed by the graphics processing unit comprises:
configuring the central processing unit to set an area related to the data required for the task in a physical memory associated with the virtual memory record to a removal-prohibited-enable state before the graphics processing unit begins executing the task and until the execution of the task is completed to configure the central processing unit to set the area being removal-prohibited in the physical memory associated with the virtual memory record to a removal-prohibited-disable state.

3. The method as claimed in claim 2, wherein the configuring the central processing unit to set the area related to the data required for the task in the physical memory associated with the virtual memory record to the removal-prohibited-enable state before the graphics processing unit begins executing the task comprises:
configuring the central processing unit to prefetch a plurality of pages associated with the data to the physical memory and to prohibit the pages including the data required for the task from being removed from the physical memory before the graphics processing unit begins executing the task.

4. The method as claimed in claim 2, wherein the configuring the central processing unit to set the area related to the data required for the task in the physical memory associated with the virtual memory record to the removal-prohibited-enable state comprises:
configuring the central processing unit to determine whether the data is available in the physical memory;
in response to the central processing unit determining the data being available in the physical memory, configuring the central processing unit to set the area related to the data required for the task in the physical memory to the removal-prohibited-enable state; and
in response to the central processing unit determining the data being unavailable in the physical memory, configuring the central processing unit to store the data in the physical memory and to set the area related to the data required for the task in the physical memory to the removal-prohibited-enable state.

5. The method as claimed in claim 1, wherein the configuring the central processing unit to assign the task to be executed by the graphics processing unit comprises configuring the central processing unit to set the task to be a single task or to set the task to comprise a plurality of batch-operating subtasks in a batch operation.

6. The method as claimed in claim 1, wherein the configuring the central processing unit to assign the task to be executed by the graphics processing unit comprises configuring the central processing unit to set a locked range of a physical memory associated with the virtual memory record to be 35% to 65% of an access space of the physical memory before the graphics processing unit begins executing the task.

7. The method as claimed in claim 1, wherein the virtual memory record is a page table.

8. A system for processing data based on shared virtual memory, comprising a central processing unit and a graphics processing unit, the central processing unit and the graphics processing unit configured to share a virtual memory record in a storage medium, wherein the virtual memory record is associated with at least one instruction; when the central processing unit executes the at least one instruction, the central processing unit assigns a task to be executed by the graphics processing unit, data required for the task is associated with the virtual memory record, and the central processing unit is configured to anchor the data required for the task during the task executed by the graphics processing unit.

9. The system as claimed in claim 8, wherein the central processing unit is configured to set an area related to the data required for the task in a physical memory associated with the virtual memory record to a removal-prohibited-enable state before the graphics processing unit begins executing the task and until the execution of the task is completed to configure the central processing unit to set the area being removal-prohibited in the physical memory associated with the virtual memory record to a removal-prohibited-disable state.

10. The system as claimed in claim 9, wherein the central processing unit is configured to prefetch a plurality of pages associated with the data to the physical memory and to prohibit the pages including the data required for the task from being removed from the physical memory before the graphics processing unit begins executing the task.

11. The system as claimed in claim 9, wherein the central processing unit is configured to determine whether the data is available in the physical memory; in response to the central processing unit determining the data being available in the physical memory, the central processing unit is configured to set the area related to the data required for the task in the physical memory to the removal-prohibited-enable state; and in response to the central processing unit determining the data being unavailable in the physical memory, the central processing unit is configured to store the data in the physical memory and to set the area related to the data required for the task in the physical memory to the removal-prohibited-enable state.

12. The system as claimed in claim 8, wherein the central processing unit is configured to set the task to be a single task or to set the task to comprise a plurality of batch-operating subtasks in a batch operation.

13. The system as claimed in claim 8, wherein the central processing unit is configured to set a locked range of a physical memory associated with the virtual memory record to be 35% to 65% of an access space of the physical memory before the graphics processing unit begins executing the task.

14. The system as claimed in claim 8, wherein the central processing unit is a RISC-V central processing unit generated by a virtual machine simulation.

15. The system as claimed in claim 14, wherein the graphics processing unit comprises a task dispatcher, a page fault controller, and a plurality of streaming processing cores; the plurality of streaming processing cores are coupled to the task dispatcher and the page fault controller; the task dispatcher is configured to receive the task and to dispatch the task to one of the plurality of streaming processing cores according to a working status of the plurality of streaming processing cores; the page fault controller is configured to integrate page-fault-exception information from the plurality of streaming processing cores and to issue a page-fault-exception interrupt to the virtual machine; and the plurality of streaming processing cores are configured to process the task dispatched by the task dispatcher.

16. The system as claimed in claim 15, wherein the page-fault-exception information comprises a virtual address and a streaming processing core number associated with a page fault exception occurring in one of the plurality of streaming processing cores.

17. The system as claimed in claim 8, wherein the virtual memory record is a page table.
